(19) United States
(12) Patent Application Publication
(10) Pub. No.: US 2024/0312090 A1
(43) Pub. Date: Sep. 19, 2024

(54) INTERACTIVE METHOD AND DEVICE

(71) Applicant: Lenovo (Beijing) Limited, Beijing (CN)

(72) Inventors: Xilong ZHOU, Beijing (CN); Xiaoping ZHANG, Beijing (CN)

(21) Appl. No.: 18/603,211

(22) Filed: Mar. 13, 2024

(30) Foreign Application Priority Data
Mar. 16, 2023 (CN) 202310270618.9

(51) Int. Cl. G06T 11/60; G06V 20/70

(52) U.S. Cl. CPC G06T 11/60; G06V 20/70

(57) ABSTRACT

An interactive method includes: obtaining to-be-modified display content in a display content, the display content being generated based on a first input content input by a user; obtaining semantic information of the to-be-modified display content; obtaining a second input content input by the user, and based on the second input content, modifying the semantic information of the to-be-modified display content to obtain modified semantic information; and based on the modified semantic information, modifying the display content to obtain modified display content.

### CROSS-REFERENCE TO RELATED APPLICATION

This application claims priority to Chinese Patent Application No. 2023102706189, filed on Mar. 16, 2023, and the entire content of which is incorporated herein by reference.

### TECHNICAL FIELD

The present disclosure relates to the technical field of computer technology, and more particularly, to an interactive method and device.

### BACKGROUND

Currently, artificial intelligence technology can generate content based on user input. However, if the generated content is not what the user wants, the user needs to modify the input, and the artificial intelligence technology regenerates the content based on the modified input. This interaction may cause the user to repeatedly modify the input, resulting in a poor user experience.

### SUMMARY

One aspect of the present disclosure provides an interactive method. The method includes: obtaining to-be-modified display content in a display content, the display content being generated based on a first input content input by a user; obtaining semantic information of the to-be-modified display content; obtaining a second input content input by the user, and based on the second input content, modifying the semantic information of the to-be-modified display content to obtain modified semantic information; and based on the modified semantic information, modifying the display content to obtain modified display content.

Another aspect of the present disclosure provides an interactive device. The interactive device includes a memory storing program instructions and a processor coupled to the memory and configured to execute the program instructions to: obtain to-be-modified display content in a display content, the display content being generated based on a first input content input by a user; obtain semantic information of the to-be-modified display content; obtain a second input content input by the user, and based on the second input content, modify the semantic information of the to-be-modified display content to obtain modified semantic information; and based on the modified semantic information, modify the display content to obtain modified display content.

Another aspect of the present disclosure provides a non-volatile storage medium storing program instructions. When being executed by a processor, the program instructions cause the processor to: obtain to-be-modified display content in a display content, the display content being generated based on a first input content input by a user; obtain semantic information of the to-be-modified display content; obtain a second input content input by the user, and based on the second input content, modify the semantic information of the to-be-modified display content to obtain modified semantic information; and based on the modified semantic information, modify the display content to obtain modified display content.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart of an interactive method according to some embodiments of the present disclosure;

FIG. 2 is a schematic diagram of an application scenario of an interactive method according to some embodiments of the present disclosure;

FIG. 3 is a schematic diagram of another application scenario of an interactive

method according to some embodiments of the present disclosure;

FIG. 4 is a flowchart of another interactive method according to some embodiments of the present disclosure;

FIG. 5 is a flowchart of another interactive method according to some embodiments of the present disclosure;

FIG. 6 is a flowchart of another interactive method according to some embodiments of the present disclosure;

FIG. 7 is a schematic diagram of another application scenario of an interactive method according to some embodiments of the present disclosure;

FIG. 8 is a flowchart of another interactive method according to some embodiments of the present disclosure;

FIG. 9 is a schematic diagram of another application scenario of an interactive method according to some embodiments of the present disclosure;

FIG. 10 is a schematic diagram of another application scenario of an interactive method according to some embodiments of the present disclosure;

FIG. 11 is a flowchart of another interactive method according to some embodiments of the present disclosure;

FIG. 12 is a schematic diagram of another application scenario of an interactive method according to some embodiments of the present disclosure;

FIG. 13 is a schematic diagram of another application scenario of an interactive method according to some embodiments of the present disclosure; and

FIG. 14 is a structural diagram of an interactive device according to some embodiments of the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are merely some of the embodiments of the present disclosure, not all of them. Based on the embodiments of the present disclosure, all other embodiments obtained by those of ordinary skill in the art without creative efforts fall within the scope of the present disclosure.

To make the above objectives, features, and advantages of the present disclosure more obvious and understandable, the present disclosure will be described in further detail below in conjunction with the accompanying drawings and various embodiments.

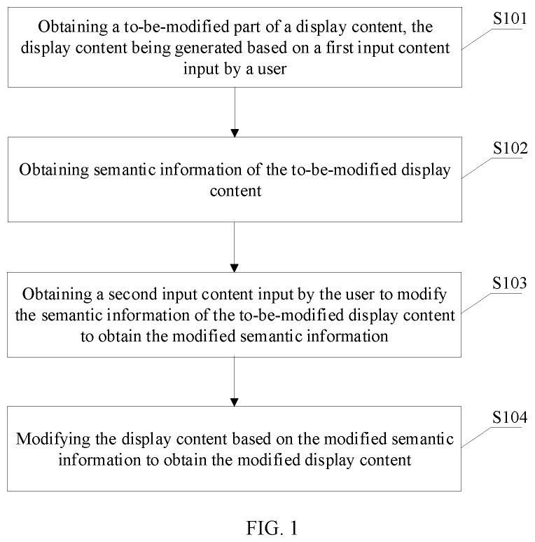

FIG. 1 is a flowchart of an interactive method according to some embodiments of the present disclosure. The method may be applied to an electronic device. The present disclosure does not limit product types of the electronic device. As shown in FIG. 1, the method may include but is not limited to the following processes.

At S101, a to-be-modified part of a display content is obtained. The display content is generated based on a first input content input by a user.

In some embodiments, the first input content input by the user may be description information corresponding to the display content. For example, the first input content is “generate a painting with mountains and rivers.”

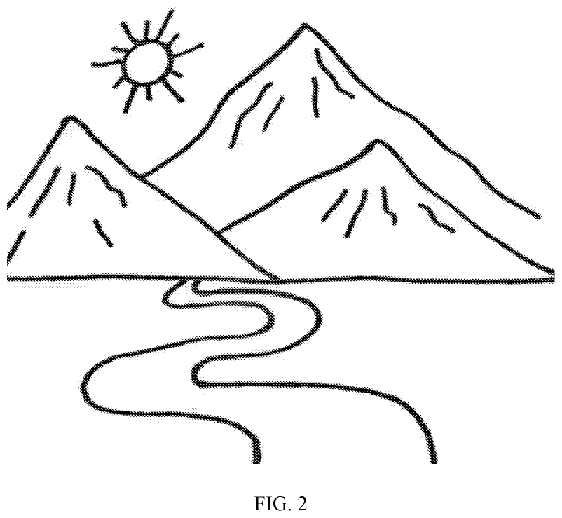

Correspondingly, generating the display content based on the first input content input by the user may include: generating the display content based on the description information corresponding to the display content. For example, based on “generate a painting of mountains and rivers”, an image (i.e., display content) as shown in FIG. 2 is generated.

The first input content input by the user may also be objects corresponding to the display content. For example, the first input content may be two images, namely an image containing mountains and an image containing rivers.

Correspondingly, generating the display content based on the first input content input by the user may include: processing the objects corresponding to the display content to obtain the display content. For example, if the first input content is an image containing mountains and an image containing rivers, the image containing mountains and the image containing rivers may be combined to obtain an image containing mountains and rivers (i.e., display content).

It should be noted that the display content is not limited to images, and the above example is merely an illustration of a method of generating the display content.

The to-be-modified display content may include: at least part of the display content. For example, if the display content is an image containing mountains and rivers as shown in FIG. 2, the to-be-modified display content can be mountains and/or rivers in the image as shown in FIG. 2.

At S102, semantic information of the to-be-modified display content is obtained.

The semantic information of the to-be-modified display content may represent a meaning of the to-be-modified display content.

The specific implementation manner of obtaining the semantic information of the to-be-modified display content is not limited in the present disclosure. Specifically, after obtaining the to-be-modified display content in the display content, the semantic information of the to-be-modified display content can be directly obtained.

Of course, S102 may also include but is not limited to the following processes.

At S1021, the to-be-modified display content is highlighted.

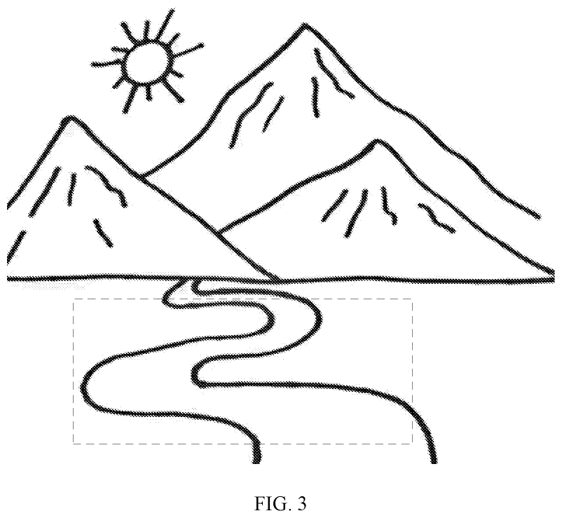

S1021 may include but is not limited to: highlighting the to-be-modified display content with at least one of a label box, a set brightness, or a set size. For example, the to-be-modified display content is the river shown in FIG. 2. As shown in FIG. 3, the river is highlighted with a label box.

In some embodiments, if at least two display contents need to be modified, each of the at least two to-be-modified display contents may be highlighted. The highlighting methods for the at least two to-be-modified display contents may be the same or different.

At S1022, in response to receiving a triggering instruction of the to-be-modified display content, the semantic information of the to-be-modified display content is obtained.

In some embodiments, the user may trigger the to-be-modified display content by entering the triggering instruction through but is not limited to: voice, text, or gesture.

In the embodiment corresponding to the at least two to-be-modified display contents, the user may trigger the to-be-modified display contents in the at least two to-be-modified display contents by entering the triggering instructions corresponding to the to-be-modified display contents.

In some embodiments, by highlighting the to-be-modified display content, the user may obtain the to-be-modified display content more intuitively. In addition, in response to the triggering instruction of the to-be-modified display content, the semantic information of the to-be-modified display content is obtained. Thus, the user is able to participate in obtaining the semantic information of the to-be-modified display content, thereby improving the user experience.

At S103, a second input content input by the user is obtained to modify the semantic information of the to-be-modified display content to obtain the modified semantic information.

In some embodiments, the user inputs the second input content corresponding to the meaning of the to-be-modified display content. The second input content may be used to modify the meaning of the to-be-modified display content.

The semantic information of the to-be-modified display content may be modified to obtain the modified semantic information corresponding to the second input content.

If at least two to-be-modified display contents are included, S103 may include but is not limited to the following process.

At S1031, the second input content input by the user to designate the to-be-modified display content is obtained, and the semantic information of the designated to-be-modified display content is modified to obtain the modified semantic information.

If at least two to-be-modified display contents are included, S103 may further include but is not limited to the following process.

At S1032, the second input contents input by the user to designate the at least two to-be-modified display contents are obtained, and the semantic information of the at least two designated to-be-modified display contents are modified to obtain the modified semantic information.

At S1032, the semantic information of the at least two to-be-modified display contents may be modified at the same time, thereby improving modification efficiency.

At S104: the display content is modified based on the modified semantic information to obtain the modified display content.

S104 may include but is not limited to the following process.

At S1041, the display content and the modified semantic information are input into a machine learning model to obtain the modified display content determined by the machine learning model.

The machine learning model may be trained based on sample display contents.

S104 may further include but is not limited to the following processes.

At S1042, a candidate display content is obtained based on the modified semantic information.

The semantic information of the candidate display content is consistent with the modified semantic information.

At S1043, the to-be-modified display content in the display content is replaced by the candidate display content to obtain the modified display content.

In the embodiments of the present disclosure, the to-be-modified display content in the display content is obtained. The semantic information of the to-be-modified display content is obtained. The second input content input by the user is obtained. The semantic information of the to-be-modified display content is modified to obtain the modified semantics information. Based on the modified semantic information, the display content is modified to obtain the modified display content. Thus, the display content is modified more accurately.

Modifying the display content more accurately at least reduces the number of user modifications and inputs, and improves the user experience.

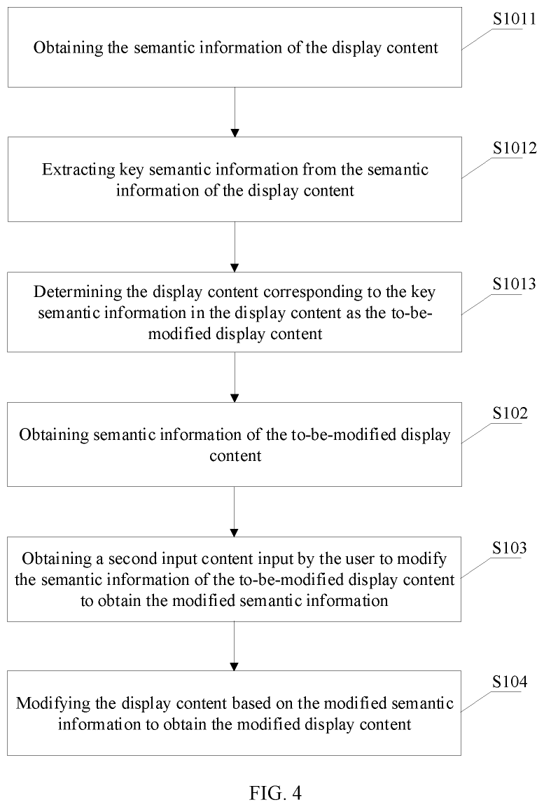

FIG. 4 is a flowchart of another interactive method according to some embodiments of the present disclosure. In some other embodiments, FIG. 4 illustrates a refinement of S101. As shown in FIG. 4, S101 may include but is not limited to the following processes.

At S1011, the semantic information of the display content is obtained.

In some embodiments, the display content is an image content, and S1011 may include but is not limited to the following process.

At S10111, semantic segmentation is performed on the image content based on a first machine learning model to obtain semantic information of each image area in the image content.

The first machine learning model is trained using sample images.

In some embodiments, the display content is a text content, and S1011 may include but is not limited to the following process.

At S10112, a content corresponding to each text line in the text content is semantically identified based on a second machine learning model to obtain the semantic information of the content corresponding to each text line.

The second machine learning model is trained using sample texts.

At S1012, key semantic information is extracted from the semantic information of the display content.

In some embodiments, semantic information corresponding to a key item in the first input content input by the user among the semantic information of the display content may be determined as key semantic information. For example, if the first input content is “Generate a painting with mountains and rivers”, the display content is the image content as shown in FIG. 2, the semantic information of the display content includes: “sun,” “mountain on the left,” ““mountain on the right,” “mountain in the distance,” and “river nearby”. The key items in “Generate a painting with mountains and rivers” are “mountain” and “river”, and the key semantic information is “mountain on the left,” “mountain on the right,” “the mountain in the distance,” and “river nearby”.

At S1013, the display content corresponding to the key semantic information in the display content is determined as the to-be-modified display content.

In the embodiment of the present disclosure, the semantic information of the display content is obtained. The key semantic information is extracted from the semantic information of the display content. The display content corresponding to the key semantic information in the display content is determined as the to-be-modified display content. Thus, the to-be-modified display content is obtained.

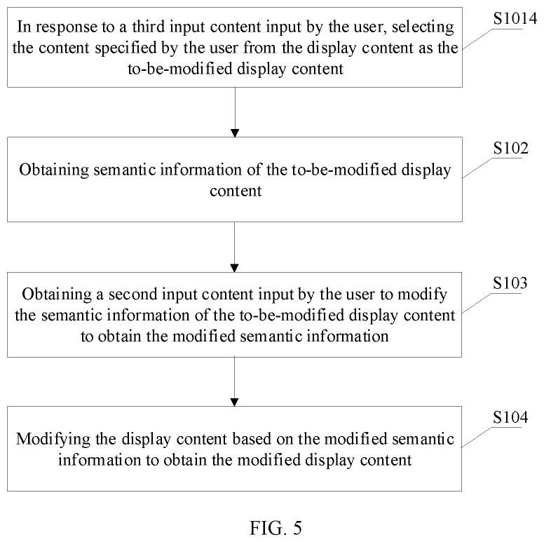

FIG. 5 is a flowchart of another interactive method according to some embodiments of the present disclosure. In some other embodiments, FIG. 5 illustrates another refinement of S101. As shown in FIG. 5, S101 may include but is not limited to the following processes.

At S1014, in response to a third input content input by the user, the content specified by the user is selected from the display content as the to-be-modified display content.

In some embodiments, the third input content input by the user is used to specify the content in the display content. The user may input the third input content through but not limited to: voice, text or gesture.

In some other embodiments, the to-be-modified display content is obtained through user participation, which further improves the user experience.

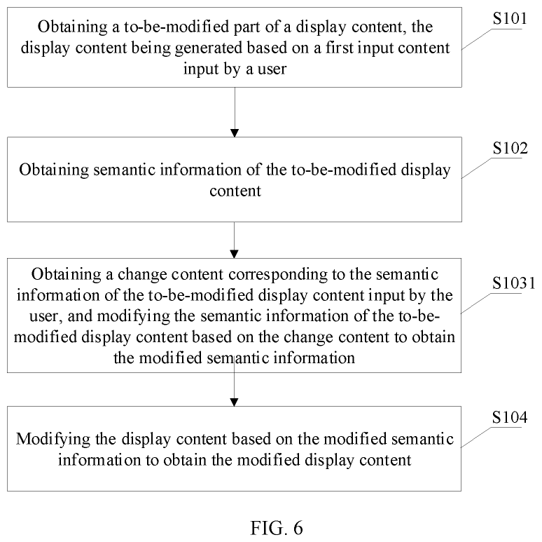

FIG. 6 is a flowchart of another interactive method according to some embodiments of the present disclosure. In some other embodiments, FIG. 6 illustrates another refinement of S103. As shown in FIG. 6, S103 may include but is not limited to the following processes.

At S1031, a change content corresponding to the semantic information of the to-be-modified display content input by the user is obtained, and the semantic information of the to-be-modified display content is modified based on the change content to obtain the modified semantic information.

In some embodiments, the user may input the change content corresponding to the semantic information of the to-be-modified display content. The change content may be interpreted as: the content used to indicate changing the semantic information of the to-be-modified display content to target semantic information.

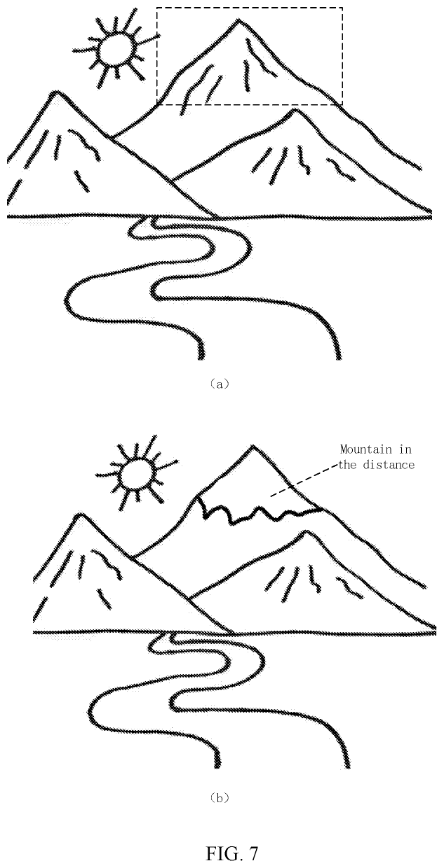

For example, if the to-be-modified display content includes a mountain marked by a dotted box in the image as shown in part (a) of FIG. 7, the semantic information of the mountain marked by the dotted box is “mountain in the distance”, and the user input change content corresponding to “mountain in the distance” is “change the mountain in the distance into a snow mountain”. Based on “change the mountain in the distance into a snow mountain”, the semantic information of the to-be-modified display content can be modified to “snow mountain in the distance”.

Correspondingly, based on “snow mountain in the distance”, the image shown in part (a) of FIG. 7 is modified to the image shown in part (b) of FIG. 7.

It should be noted that the dotted lines, dotted boxes, and texts shown in FIG. 7 are descriptions of the display content and are not displayed as labels.

In the embodiments of the present disclosure, the to-be-modified display content in the display content is obtained. The semantic information of the to-be-modified display content is obtained. The change content corresponding to the semantic information of the to-be-modified display content input by the user is obtained. Based on the change content, the semantic information of the to-be-modified display content is modified to obtain the modified semantic information. Based on the modified semantic information, the display content is modified to obtain the modified display content. Thus, the display content is modified more accurately.

Modifying the display content more accurately at least reduces the number of user modifications and inputs, and improves the user experience.

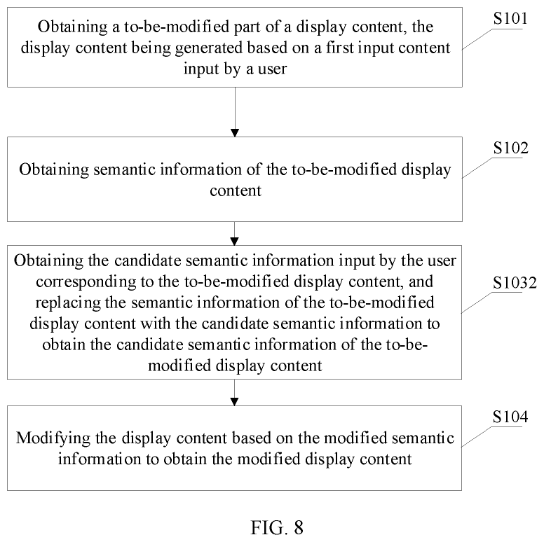

FIG. 8 is a flowchart of another interactive method according to some embodiments of the present disclosure. In some other embodiments, FIG. 8 illustrates another refinement of S103. As shown in FIG. 8, S103 may include but is not limited to the following processes.

At S1032, the candidate semantic information input by the user corresponding to the to-be-modified display content is obtained, and the candidate semantic information replaces the semantic information of the to-be-modified display content to obtain the candidate semantic information of the to-be-modified display content.

In some embodiments, the user may input the candidate semantic information corresponding to the to-be-modified display content. For example, if the to-be-modified display content includes a mountain marked by a dotted box in the image as shown in part (a) of FIG. 7, the semantic information of the mountain marked by the dotted box is “mountain in the distance”. For the mountain marked by the dotted box, the user inputs “snow mountain in the distance”. “snow mountain in the distance” replaces “mountain in the distance”. The candidate semantic information of the mountain marked by the dotted box is obtained as “snow mountain in the distance”.

Corresponding to S1032, S104 may include the following process.

At S1044, based on the candidate semantic information of the to-be-modified display content, the display content is modified to obtain the modified display content.

Correspondingly, based on “snow mountain in the distance”, the image shown in part (a) of FIG. 7 is modified to the image shown in part (b) of FIG. 7.

It should be noted that the dotted lines, dotted boxes, and texts shown in FIG. 7 are descriptions of the display content and are not displayed as labels.

In the embodiments of the present disclosure, the to-be-modified display content in the display content is obtained. The semantic information of the to-be-modified display content is obtained. The candidate semantic information corresponding to the to-be-modified display content that is input by the user is obtained. The candidate semantic information replaces the semantic information of the to-be-modified display content to obtain the candidate semantic information of the to-be-modified display content. Based on the candidate semantic information, the display content is modified to obtain the modified display content. Thus, the display content is modified more accurately.

Modifying the display content more accurately at least reduces the number of user modifications and inputs, and improves the user experience.

In some other embodiments, S103 is further refined. As such, S103 may include but is not limited to the following process.

At S1033, the second input content input by the user is obtained. The semantic information of the to-be-modified display content is modified to obtain modified semantic information.

In some embodiments, the second input content input by the user is used to modify the meaning of the to-be-modified display content.

Modifying the meaning of the to-be-modified display content may include but is not limited to: modifying the meaning of the to-be-modified display content to change the category of the to-be-modified display content, or modifying the meaning of the to-be-modified display content without changing the category of the to-be-modified display content.

The second input content may be used to modify the meaning of the to-be-modified display content to change the category of the to-be-modified display content. Modifying the semantic information of the to-be-modified display content to obtain the modified semantic information may include: through changing the category of the to-be-modified display content, modifying the semantic information of the to-be-modified display content to obtain the modified semantic information.

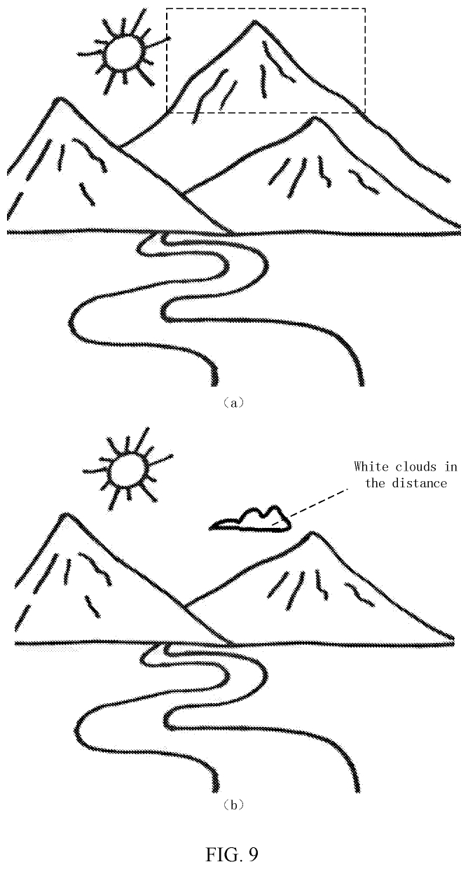

For example, if the to-be-modified display content includes a mountain marked by a dotted box in the image as shown in part (a) of FIG. 9, the semantic information of the mountain marked by the dotted box is “mountain in the distance”. For the mountain marked by the dotted box, the user inputs the second input content for changing the mountain marked by the dotted box to white clouds.

Corresponding to the second input content, “mountain in the distance” is changed to “white clouds in the distance”. Correspondingly, based on the “white clouds in the distance”, the image shown in part (a) of FIG. 9 is modified to the image shown in part (b) of FIG. 9.

It should be noted that the dotted lines, dotted boxes, and texts shown in FIG. 9 are descriptions of the display content and are not displayed as labels.

The second input content may be used to modify the meaning of the to-be-modified display content without changing the category of the to-be-modified display content. Modifying the semantic information of the to-be-modified display content to obtain the modified semantic information may include: through keeping the category of the to-be-modified display content unchanged, modifying the semantic information of the to-be-modified display content to obtain the modified semantic information.

For example, if the to-be-modified display content includes a mountain marked by a dotted box in the image as shown in part (a) of FIG. 7, the semantic information of the mountain marked by the dotted box is “mountain in the distance”. For the mountain marked by the dotted box, the user inputs the second input content for changing the mountain marked by the dotted box to a snow mountain. Corresponding to the second input content, “mountain in the distance” is changed to “snow mountain in the distance”.

S103 may also include but is not limited to the following process.

At S1035, the second input content input by the user is obtained. The semantic information of the to-be-modified display content is expanded to obtain expanded semantic information.

In some embodiments, the second input content input by the user may be used to expand the meaning of the to-be-modified display content.

Based on the expanded semantic information, the modified display content obtained by modifying the display content contains more content than the display content.

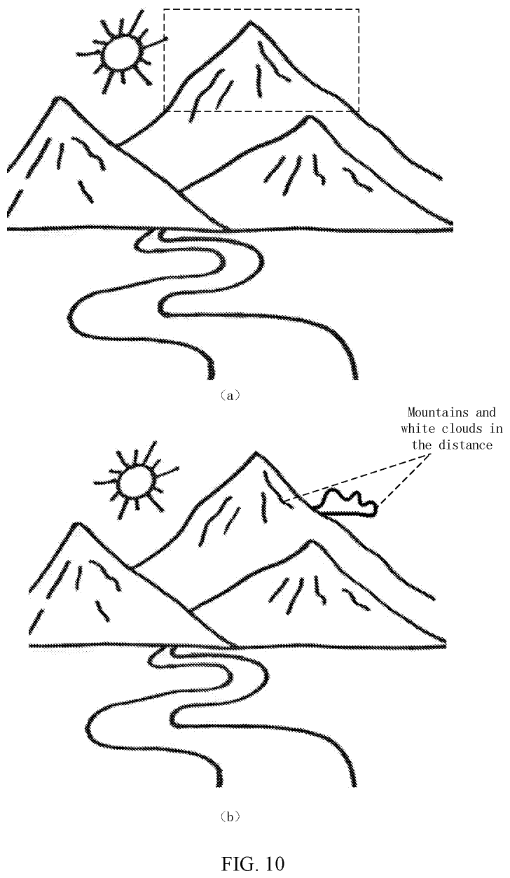

For example, if the to-be-modified display content includes a mountain marked by a dotted box in the image as shown in part (a) of FIG. 10, the semantic information of the mountain marked by the dotted box is “mountain in the distance”. For the mountain marked by the dotted box, the user inputs the second input content for expanding the mountain marked by the dotted box into mountains and white clouds. Corresponding to the second input content, “mountain in the distance” is expanded to “mountain and white clouds in the distance”. Accordingly, based on the “mountain and white clouds in the distance”, the image shown in part (a) of FIG. 10 is modified to the image shown in part (b) of FIG. 10.

It should be noted that the dotted lines, dotted boxes, and texts shown in FIG. 10 are descriptions of the display content and are not displayed as labels.

Of course, S1034 and S1035 may be combined as another implementation of S103. The method of combining S1034 and S1035 is not limited in the present disclosure.

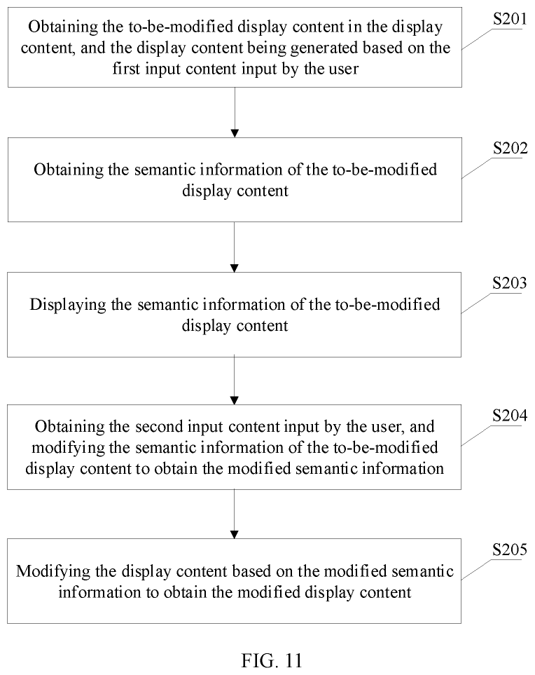

FIG. 11 is a flowchart of another interactive method according to some embodiments of the present disclosure. The interactive method shown in FIG. 11 is an extension of the interactive method shown in FIG. 1. As shown in FIG. 11, the interactive method may include but is not limited to the following processes.

At S201, the to-be-modified display content in the display content is obtained, and the display content is generated based on the first input content input by the user.

At S202, the semantic information of the to-be-modified display content is obtained.

For details of S201-S202, reference can be made to the relevant descriptions of S101-S102, which will be omitted herein.

At S203, the semantic information of the to-be-modified display content is displayed.

In some embodiments, the way in which the semantic information of the to-be-modified display content is displayed is not limited by the present disclosure.

Specifically, displaying the semantic information of the to-be-modified display content may include but is not limited to: displaying a pop-up window on a display interface, where the pop-up window contains the semantic information of the to-be-modified display content.

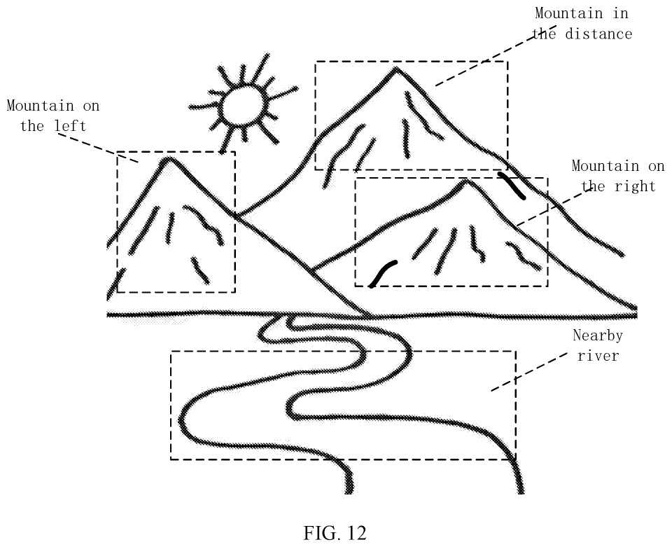

Displaying the semantic information of the to-be-modified display content may also include but is not limited to: displaying the semantic information of the to-be-modified display content as annotation of the to-be-modified display content. For example, if the to-be-modified display content includes mountains and a river marked by dotted boxes as shown in FIG. 12, the semantic information of the to-be-modified display content includes: “mountain on the left,” “mountain on the right,” “mountain in the distance,” and “nearby river.” As shown in FIG. 12, “mountain on the left,” “mountain on the right,” “mountain in the distance,” and “nearby river ” are displayed as annotations of the mountains and the river marked by the dotted boxes.

At S204, the second input content input by the user is obtained, and the semantic information of the to-be-modified display content is modified to obtain the modified semantic information.

In some embodiments, the user inputs the second input content based on the semantic information of the to-be-modified displayed content.

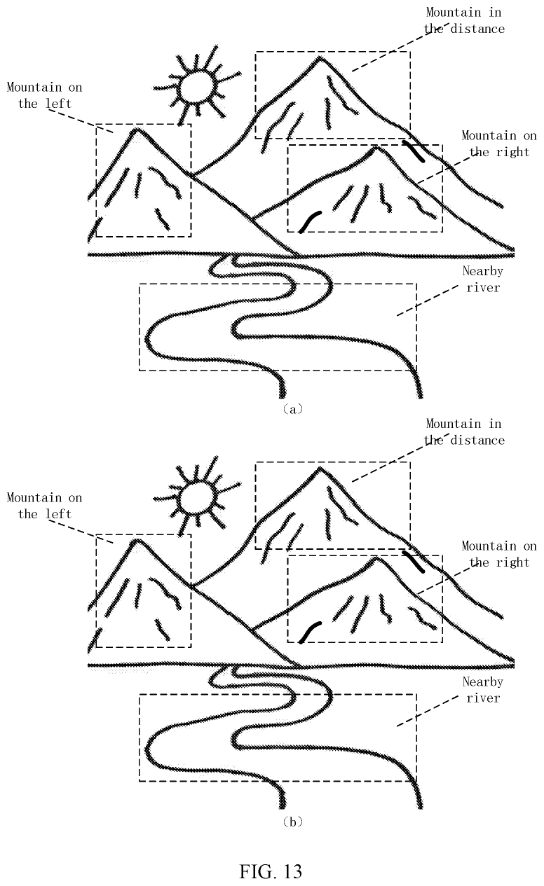

In some embodiments, the semantic information of the to-be-modified display content is displayed as the annotation of the to-be-modified display content. The user may input the second input content by directly modifying the annotation of the to-be-modified display content. The second input content may be the candidate semantic information of the to-be-modified display content. For example, if the to-be-modified display content includes mountains and rivers marked by dotted boxes in part (a) of FIG. 13, the semantic information of the to-be-modified display content includes: “mountain on the left,” “mountain on the right,” “mountain in the distance,” and “nearby river.” “mountain on the left,” “mountain on the right,” “mountain in the distance,” and “nearby river” are displayed as the annotation of the mountains and the river marked by the dotted boxes as shown in part (a) of FIG. 13. If “mountain in the distance” needs to be modified to “snow mountain in the distance” as shown in part (b) of FIG. 13, “mountain in the distance” is directly modified to “snow mountain in the distance”.

At S205, the display content is modified based on the modified semantic information to obtain the modified display content.

For the detailed process of steps S204-S205, please refer to the relevant introduction of steps S103-S104 in Embodiment 1, which will not be described again here.

For details of S204-S205, reference can be made to the relevant descriptions of S103-S104, which will be omitted herein.

In the embodiments of the present disclosure, the to-be-modified display content in the display content is obtained. The semantic information of the to-be-modified display content is obtained. The semantic information of the to-be-modified display content is displayed. The second input content input by the user is obtained. The semantic information of the to-be-modified display content is modified to obtain the modified semantic information. Based on the modified semantic information, the display content is modified to obtain the modified display content. Thus, the display content is modified more accurately.

Modifying the display content more accurately at least reduces the number of user modifications and inputs, and improves the user experience.

Moreover, by displaying the semantic information of the to-be-modified display content, the user can input the second input content based on the displayed semantic information, thereby further improving the user experience.

The present disclosure also provides an interactive device. The interactive device and the interactive method share common technical solutions. When describing the interactive device, reference will be made to the interactive method.

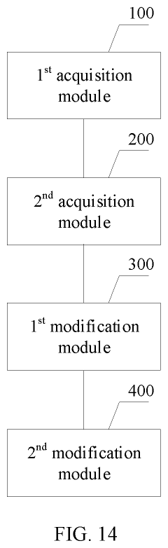

FIG. 14 is a structural diagram of an interactive device according to some embodiments of the present disclosure. As shown in FIG. 14, the interaction device includes: a first acquisition module 100, a second acquisition module 200, a first modification module 300, and a second modification module 400.

The first acquisition module 100 is configured to obtain the to-be-modified display content in the display content. The display content is generated based on the first input content input by the user.

The second acquisition module 200 is configured to obtain the semantic information of the to-be-modified display content.

The first modification module 300 is configured to obtain the second input content input by the user, and modify the semantic information of the to-be-modified display content to obtain the modified semantic information.

The second modification module 400 is configured to modify the display content based on the modified semantic information to obtain the modified display content.

In some embodiments, the first acquisition module 100 may be specifically configured to: obtain the semantic information of the display content, extract the key semantic information from the semantic information of the display content, and determine the display content corresponding to the key semantic information in the display content as the to-be-modified display content; or, in response to the third input content input by the user, select the content specified by the user from the display content as the to-be-modified display content.

The first modification module 300 may be specifically configured to: obtain the change content corresponding to the semantic information of the to-be-modified display content input by the user, and modify the semantic information of the to-be-modified display content based on the change content to obtain the modified semantic information; or, obtain the candidate semantic information corresponding to the to-be-modified display content input by the user, replace the semantic information of the to-be-modified display content with the candidate semantic information to obtain the candidate semantic information of the to-be-modified display content.

In some embodiments, the first modification module 300 may be specifically configured to: obtain the second input content input by the user, and modify the semantic information of the to-be-modified display content to obtain the modified semantic information; and/or, obtain the second input content input by the user, and expand the semantic information of the to-be-modified display content to obtain the expanded semantic information.

The process for the first modification module 300 to modify the semantic information of the to-be-modified display content to obtain the modified semantic information may include: through changing the category of the to-be-modified display content, modifying the semantic information of the to-be-modified display content to obtain modified semantic information.

If at least two display contents need to be modified, the first modification module 300 may be configured to: obtain the second input content input by the user corresponding to the at least two to-be-modified display contents, and modify the semantic information of the at least two to-be-modified display contents to obtain the modified semantic information.

In some embodiments, the second modification module 400 may be specifically configured to: based on the modified semantic information, obtain the candidate display content, and replace the to-be-modified display content in the display content with the candidate display content to obtain the modified display content.

The second acquisition module 200 may be specifically configured to: highlight the to-be-modified display content, and in response to the triggering instruction of the to-be-modified display content, obtain the semantic information of the to-be-modified display content.

In some embodiments, the interactive device may also include: a display module configured to display the semantic information of the to-be-modified display content.

The present disclosure also provides an electronic device. The electronic device is configured to perform the processes in the interactive method previously described.

The electronic device may include the following structures: a memory and a processor.

The memory stores at least a set of instructions. The processor is configured to call and execute the set of instructions stored in the memory to perform the interactive method as described in any of the embodiments of the interactive method.

The present disclosure also provides a non-volatile storage medium. The non-volatile storage medium stores a computer program for implementing the interactive method previously described.

In some embodiments, the non-volatile storage medium stores the computer program that implements the interactive method as described in any one of embodiments of the present disclosure. The computer program is executed by a processor to perform any of the embodiments of the interaction methods previously described.

It should be noted that each embodiment focuses on its differences from other embodiments, and the same and similar parts between the various embodiments can be referred to each other. Because the device embodiments are basically similar to the method embodiments, the description thereof is relatively simple. For relevant details, reference can be made to the description of the method embodiments.

Further, it should be noted that in the specification, relational terms such as first and second are merely used to distinguish one entity or operation from another entity or operation, and do not necessarily require or imply that any such relationship or sequence exists between the entities or between the operations. Furthermore, the terms “comprises,” “includes,” or any other variations thereof are intended to cover a non-exclusive inclusion such that a process, a method, an article, or an apparatus that includes a list of elements includes not only those elements, but also other elements not expressly listed, or elements inherent to the process, the method, the article, or the apparatus. Without further limitation, an element defined by the statement “comprises a . . . ” does not exclude the presence of additional identical elements in a process, a method, an article, or an apparatus that includes the stated element.

For the convenience of description, when describing the above device, the functions are divided into various modules and described separately. Of course, when implementing the above device, the functions of each module can be implemented in the same or multiple software and/or hardware.

From the above description of the embodiments, those skilled in the art may clearly understand that the present disclosure can be implemented by means of software plus necessary general hardware platform. Based on this understanding, the technical solution of the present disclosure in essence or the portion that contributes beyond the existing technology may be embodied in the form of a computer software product. The computer software product may be stored in a storage medium, such as a ROM/RAM, a magnetic disk, an optical disk, etc., including a number of instructions to cause a computer device (which can be a personal computer, a server, or a network device, etc.) to perform the interactive method described in various embodiments or certain parts of the embodiments of the present disclosure.

The interactive method and the interactive device provided by the present disclosure have been describe in detail above. Specific examples are used in the specification to illustrate the principles and implementation methods of the present disclosure. The description of the above embodiments is merely used to help understand the methods and principles of the present disclosure. At the same time, for those of ordinary skill in the art, changes and modifications can be made to the specific implementations and application scopes based on the ideas of the present disclosure. The contents of the specification should not be construed as limitations of the present disclosure.

What is claimed is:

1. An interactive method, comprising:
obtaining to-be-modified display content in a display content, the display content being generated based on a first input content input by a user;
obtaining semantic information of the to-be-modified display content;
obtaining a second input content input by the user, and based on the second input content, modifying the semantic information of the to-be-modified display content to obtain modified semantic information; and
based on the modified semantic information, modifying the display content to obtain modified display content.

2. The method according to claim 1, wherein obtaining the to-be-modified display content in the display content comprises:
obtaining semantic information of the display content;
extracting key semantic information from the semantic information of the display content; and
determining the display content corresponding to the key semantic information in the display content as the to-be-modified display content; or
in response to a third input content input by the user, selecting a content specified by the user from the display content as the to-be-modified display content.

3. The method according to claim 1, wherein obtaining the second input content input by the user, and based on the second input content, modifying the semantic information of the to-be-modified display content to obtain the modified semantic information comprises:
obtaining change content input by the user corresponding to the semantic information of the to-be-modified display content, and based on the change content, modifying the semantic information of the to-be-modified display content to obtain the modified semantic information; or
obtaining candidate semantic information input by the user corresponding to the to-be-modified display content, and replacing the semantic information of the to-be-modified display content with the candidate semantic information to obtain the candidate semantic information of the to-be-modified display content.

4. The method according to claim 1, wherein obtaining the second input content input by the user, and based on the second input content, modifying the semantic information of the to-be-modified display content to obtain the modified semantic information comprises:
obtaining the second input content input by the user, and modifying the semantic information of the to-be-modified display content to obtain modified semantic information; and/or
obtaining the second input content input by the user, and expanding the semantic information of the to-be-modified display content to obtain expanded semantic information.

5. The method according to claim 4, wherein modifying the semantic information of the to-be-modified display content to obtain the modified semantic information comprises:
through changing a category of the to-be-modified display content, modifying the semantic information of the to-be-modified display content to obtain the modified semantic information.

6. The method according to claim 1, wherein at least two to-be-modified display contents need to be modified, obtaining the second input content input by the user, and based on the second input content, modifying the semantic information of the to-be-modified display content to obtain the modified semantic information comprises:
obtaining the second input content input by the user corresponding to the at least two to-be-modified display contents, and based on the second input content, modifying the semantic information of the at least two to-be-modified display contents to obtain the modified semantic information.

7. The method according to claim 1, wherein based on the modified semantic information, modifying the display content to obtain the modified display content comprises:
based on the modified semantic information, obtaining a candidate display content; and
replacing the to-be-modified display content in the display content with the candidate display content to obtain the modified display content.

8. The method according to claim 1, wherein obtaining the semantic information of the to-be-modified display content comprises:
highlighting the to-be-modified display content; and
in response to a triggering instruction of the to-be-modified display content, obtaining the semantic information of the to-be-modified display content.

9. The method according to claim 1, after obtaining the semantic information of the to-be-modified display content, further comprising:
displaying the semantic information of the to-be-modified display content.

10. An interactive device comprising a memory storing program instructions and a processor coupled to the memory and configured to execute the program instructions to:
obtain to-be-modified display content in a display content, the display content being generated based on a first input content input by a user;
obtain semantic information of the to-be-modified display content;
obtain a second input content input by the user, and based on the second input content, modify the semantic information of the to-be-modified display content to obtain modified semantic information; and
based on the modified semantic information, modify the display content to obtain modified display content.

11. The device according to claim 10, wherein when obtaining the to-be-modified display content in the display content, the processor is further configured to:
obtain semantic information of the display content;
extract key semantic information from the semantic information of the display content; and
determine the display content corresponding to the key semantic information in the display content as the to-be-modified display content; or
in response to a third input content input by the user, select a content specified by the user from the display content as the to-be-modified display content.

12. The device according to claim 10, wherein when obtaining the second input content input by the user, and based on the second input content, modifying the semantic information of the to-be-modified display content to obtain the modified semantic information, the processor is further configured to:
obtain change content input by the user corresponding to the semantic information of the to-be-modified display content, and based on the change content, modify the semantic information of the to-be-modified display content to obtain the modified semantic information; or
obtain candidate semantic information input by the user corresponding to the to-be-modified display content, and replace the semantic information of the to-be-modified display content with the candidate semantic information to obtain the candidate semantic information of the to-be-modified display content.

13. The device according to claim 10, wherein when obtaining the second input content input by the user, and based on the second input content, modifying the semantic information of the to-be-modified display content to obtain the modified semantic information, the processor is further configured to:
obtain the second input content input by the user, and modify the semantic information of the to-be-modified display content to obtain modified semantic information; and/or
obtain the second input content input by the user, and expand the semantic information of the to-be-modified display content to obtain expanded semantic information.

14. The device according to claim 13, wherein when modifying the semantic information of the to-be-modified display content to obtain the modified semantic information, the processor is further configured to:
through changing a category of the to-be-modified display content, modify the semantic information of the to-be-modified display content to obtain the modified semantic information.

15. The device according to claim 10, wherein at least two to-be-modified display contents need to be modified, and when obtaining the second input content input by the user, and based on the second input content, modifying the semantic information of the to-be-modified display content to obtain the modified semantic information, the processor is further configured to:
obtain the second input content input by the user corresponding to the at least two to-be-modified display contents, and based on the second input content, modify the semantic information of the at least two to-be-modified display contents to obtain the modified semantic information.

16. The device according to claim 10, wherein when based on the modified semantic information, modifying the display content to obtain the modified display content, the processor is further configured to:
based on the modified semantic information, obtain a candidate display content; and
replace the to-be-modified display content in the display content with the candidate display content to obtain the modified display content.

17. The device according to claim 10, wherein when obtaining the semantic information of the to-be-modified display content, the processor is further configured to:
highlight the to-be-modified display content; and
in response to a triggering instruction of the to-be-modified display content, obtain the semantic information of the to-be-modified display content.

18. The device according to claim 10, wherein after obtaining the semantic information of the to-be-modified display content, the processor is further configured to:
display the semantic information of the to-be-modified display content.

19. A non-volatile computer readable storage medium storing program instructions, when being executed by one or more processors, the program instructions causing the one or more processors to:
obtain to-be-modified display content in a display content, the display content being generated based on a first input content input by a user;
obtain semantic information of the to-be-modified display content;
obtain a second input content input by the user, and based on the second input content, modify the semantic information of the to-be-modified display content to obtain modified semantic information; and
based on the modified semantic information, modify the display content to obtain modified display content.

20. The non-volatile storage medium according to claim 19, wherein when obtaining the to-be-modified display content in the display content, the processor is further configured to:
obtain semantic information of the display content;
extract key semantic information from the semantic information of the display content; and
determine the display content corresponding to the key semantic information in the display content as the to-be-modified display content; or
in response to a third input content input by the user, select a content specified by the user from the display content as the to-be-modified display content.
